(19) United States
(12) Patent Application Publication
(10) Pub. No.: US 2016/0323455 A1
(43) Pub. Date: Nov. 3, 2016

(54) ALGORITHM FOR DTMF DETECTION

(71) Applicant: National Taipei University of Technology, Taipei City (TW)

(72) Inventors: Shaw Hwa HWANG, Taipei City (TW); Li Te SHEN, Taipei City (TW); Kuan Lin CHEN, Taipei City (TW); Yao Hsing CHUNG, Taipei City (TW); Chi Jung HUANG, Taipei City (TW); Cheng Yu YEH, Taipei City (TW); Shun Chieh CHANG, Taipei City (TW); Bing Chih YAO, Taipei City (TW); Chao Ping CHU, Taipei City (TW); Ning Yun KU, Taipei City (TW); Tzu Hung LIN, Taipei City (TW); Ming Che YEH, Taipei City (TW)

(21) Appl. No.: 14/700,354

(22) Filed: Apr. 30, 2015

(51) Int. Cl. H04M 7/12

(52) U.S. Cl. CPC H04M 7/1295

(57) ABSTRACT

The calculation for DFT(Discrete Fourier Transform) is too much in prior art, so the present invention provides a new method DMFT(Discrete Multi-Frequency Transform) for calculation. For example, in prior art, to determine a DTMF signal “3”, the calculation must be performed for k=96˜92 (frequency 1477 Hz with tolerance ±2.5%) and k=45˜43 (frequency 697 Hz with tolerance ±2.5%), total 8 of X[k] value have to be calculated, but the present invention performs a single calculation of X[k] for each frequency. To determine a DTMF signal “3”, only a high frequency of X[k] and a low frequency of X[k] are required to calculate.

### FIELD OF THE INVENTION

The present invention relates to a new algorithm for DTMF detection, and more particularly to an algorithm for reducing calculation by utilizing optimal phase or gain.

### BACKGROUND OF THE INVENTION

DTMF (Dual-Tone Multi-Frequency) signals are broadly used in PSTN (Public Switched Telecommunication Network) for telephone dialing, data input, voice mail and remote control of consumer products. DTMF signals are used for transmitting numbers. Table 1 shows the combination of DTMF high frequency and low frequency for each telephone key, for example, push the key “1” means two signals of frequency 697 Hz and 1209 Hz are outputted, and so on.

TABLE 1

high freq.

| low freq. | 1209 Hz | 1336 Hz | 1477 Hz | 1633 Hz |
|---|---|---|---|---|
| 697 Hz | 1 | 2 | 3 | A |
| 770 Hz | 4 | 5 | 6 | B |
| 852 Hz | 7 | 8 | 9 | C |
| 941 Hz | * | 0 | # | D |

In accordance with the ITU (International Telecommunication Union) standard, the acceptable tolerance for DTMF frequency is ±1.5%; if the frequency deviation exceeds ±3.5%, then it is unaccepatable; for frequency deviation between ±1.5%˜±3.5%, the user decides it is acceptable or unaccepatable. The reason that ITU specifies the acceptable tolerance for DTMF frequency is because a signal transmitting or converting between devices may induce frequency shift. A DTMF signal is composed of a high frequency signal and a low frequency signal.

In prior art, DFT (Discrete Fourier Transform) method is used for detecting DTMF signals, the signals in time domain is converted into a spectrum in frequency domain, as shown in FIG. 1. In FIG. 1, the sampling length N is 512, the sampling frequency SR is 8000 Hz, a detection of high frequency 1477 Hz for key “3” is performed, in which k is proportional to frequency (k=1 corresponds to 15.625 Hz), so the k corresponding to 1477 Hz is 940528≈95, while the k corresponding to 697 Hz is 44.608≈44, as shown in FIG. 2. The formula is as below:

$$f = k * \frac{SR}{N} ⇒ k = \frac{f * N}{SR} = \frac{1477 * 512}{8000} = 94.528 .$$

The acceptable tolerance for DTMF frequency is ±2.5% according to the present invention.

As the above setting, 512 samplings are taken each time, and the frequencies contained in the 512 samplings are analyzed, with frequency range 0 Hz˜8000 Hz. The acceptable range of k around 1477 Hz and 697 Hz are calculated as below:

f: 1477 Hz

$$k = \frac{f * N}{SR} = \frac{1477 * 512}{8000} = 94.528$$

upper limit

$$k * ( 1 + 1.5 \% ) = \frac{f * N}{SR} * ( 1 + 1.5 \% ) = \frac{1477 * 512}{8000} * ( 1 + 1.5 \% ) = 95.94592$$

lower limit

$$k * ( 1 - 1.5 \% ) = \frac{f * N}{SR} * ( 1 - 1.5 \% ) = \frac{1477 * 512}{8000} * ( 1 - 1.5 \% ) = 93.11008$$

The upper limit and the lower limit above are the acceptable range specified by ITU.

upper limit

$$k * ( 1 + 2.5 \% ) = \frac{f * N}{SR} * ( 1 + 2.5 \% ) = \frac{1477 * 512}{8000} * ( 1 + 2.5 \% ) = 96.8912$$

lower limit

$$k * ( 1 - 2.5 \% ) = \frac{f * N}{SR} * ( 1 - 2.5 \% ) = \frac{1477 * 512}{8000} * ( 1 - 2.5 \% ) = 92.1648$$

The upper limit and the lower limit above are the acceptable range specified by the present invention.

f: 697 Hz

$$k = \frac{f * N}{SR} = \frac{697 * 512}{8000} = 44.608$$

upper limit

$$k * ( 1 + 1.5 \% ) = \frac{f * N}{SR} * ( 1 + 1.5 \% ) = \frac{697 * 512}{8000} * ( 1 + 1.5 \% ) = 45.27712$$

lower limit

$$k * ( 1 - 1.5 \% ) = \frac{f * N}{SR} * ( 1 - 1.5 \% ) = \frac{697 * 512}{8000} * ( 1 - 1.5 \% ) = 43.93888$$

The upper limit and the lower limit above are the acceptable range specified by ITU.

upper limit

$$k * ( 1 + 2.5 \% ) = \frac{f * N}{SR} * ( 1 + 2.5 \% ) = \frac{697 * 512}{8000} * ( 1 + 2.5 \% ) = 45.7232$$

lower limit

$$k * ( 1 - 2.5 \% ) = \frac{f * N}{SR} * ( 1 - 2.5 \% ) = \frac{697 * 512}{8000} * ( 1 - 2.5 \% ) = 43.4928$$

The upper limit and the lower limit above are the acceptable range specified by the present invention.

All of the above k values must be integer, since the index values in memory array of communication hardware device or computer system are integers. In judging if DTMF is “3”, five points of K=96˜92 (frequency tolerance range ±2.5% of 1477 Hz) and three points of K=45˜43 (frequency tolerance range ±2.5% of 697 Hz) have to be checked to see if a minimum value exists for each of the 8 points.

In prior art, the calculation formula of DFT is as below:

$$\begin{matrix}X [ k ] = {\sum }_{n = 0}^{N - 1} x [ n ] {W}_{N}^{kn} \\ = {\sum }_{n = 0}^{N - 1} x [ n ] {e}^{j \frac{2 π}{N} kn} \\ = {\sum }_{n = 0}^{N - 1} x [ n ] \{ cos ( \frac{2 π}{N} nk ) - j s in ( \frac{2 π}{N} nk ) \} ,\end{matrix}$$

$$k = 0 , … , N - 1$$

in which N is 512, n is 0˜512, k is also 0˜512. X[k] is the height of spectrum for frequency k, x[n] is the height of the n point in time domain. From the above formula, in order to calculate each X[k], 512×2 mutiplications and 512×2-2 additions are needed, the calculation is really too much.

The table below are concluded from the above formula to describe the calculation required for different K range in prior art DFT.

| K range | calculation required for DFT |
|---|---|
| 1 | (2N, 2N − 2) |
| 2 | (4N, 4N − 4) |
| 3 | (6N, 6N − 6) |
| 4 | (8N, 8N − 8) |
| 5 | (10N, 10N − 10) |
| 6 | (12N, 12N − 12) |

As shown in the above table of calculation required for DFT, the more the K range is increased, the calculation will be increased by multiples, the required calculation will grow up dramatically.

### SUMMARY OF THE INVENTION

The object of the present invention is to provide an algorithm for DTMF detection. In detecting DTMF signals, the signals x[n] in time domain is converted into a spectrum in frequency domain. Let the sampling length is N, and perform calculation on M points of the spectrum,

$$\begin{matrix}\tilde{X} [ k ] = {\sum }_{k = 0}^{M - 1} X [ k ] \\ = {\sum }_{k = 0}^{M - 1} x [ n ] {\sum }_{n = 0}^{N - 1} {W}_{N}^{kn} \\ = {\sum }_{k = 0}^{M - 1} x [ n ] {\sum }_{n = 0}^{N - 1} {e}^{j \frac{2 π}{N} kn} \\ = {\sum }_{k = 0}^{M - 1} x [ n ] {\sum }_{n = 0}^{N - 1} \{ cos ( \frac{2 π}{N} nk ) - j sin ( \frac{2 π}{N} nk ) \} \\ = {\sum }_{n = 0}^{N - 1} x [ n ] {\sum }_{k = 0}^{M - 1} \{ cos ( \frac{2 π}{N} nk ) - j sin ( \frac{2 π}{N} nk ) \}\end{matrix}$$

in which x[k] is the signal value at the k point of the spectrum, X[k] is the calculation result on M points of the spectrum,

$$m = \frac{f * N * 5 \%}{SR} = \frac{697 * 512 * 5 \%}{8000} = 2.2304 ≅ 3$$

In order to avoid trembling wave in pass-band of the frequency domain or to reduce the trembling degree, so as to make it work as a square wave filter like Butterworth or Chebyshev, a θ degree or A gain is added to the above formula to control the wave shape, as shown below:

$$\begin{matrix}\breve{X} [ k ] = {\sum }_{n = 0}^{N - 1} x [ n ] {\sum }_{m = 0}^{M - 1} {\breve{W}}_{Nθ}^{kn} \\ = {\sum }_{n = 0}^{N - 1} x [ n ] {\sum }_{m = 0}^{M - 1} {e}^{- j \frac{2 π n ( k + m )}{N} + ( m θ )} \\ = {\sum }_{n = 0}^{N - 1} x [ n ] {\sum }_{m = 0}^{M - 1} \{ cos ( \frac{2 π n ( k + m )}{N} + ( m θ ) ) - j sin ( \frac{2 π n ( k + m )}{N} + ( m θ ) ) \}\end{matrix}$$

### BRIEF DESCRIPTION OF THE DRAWINGS

FIG. 1 shows schematically that the signal in time domain is converted into a spectrum in frequency domain.

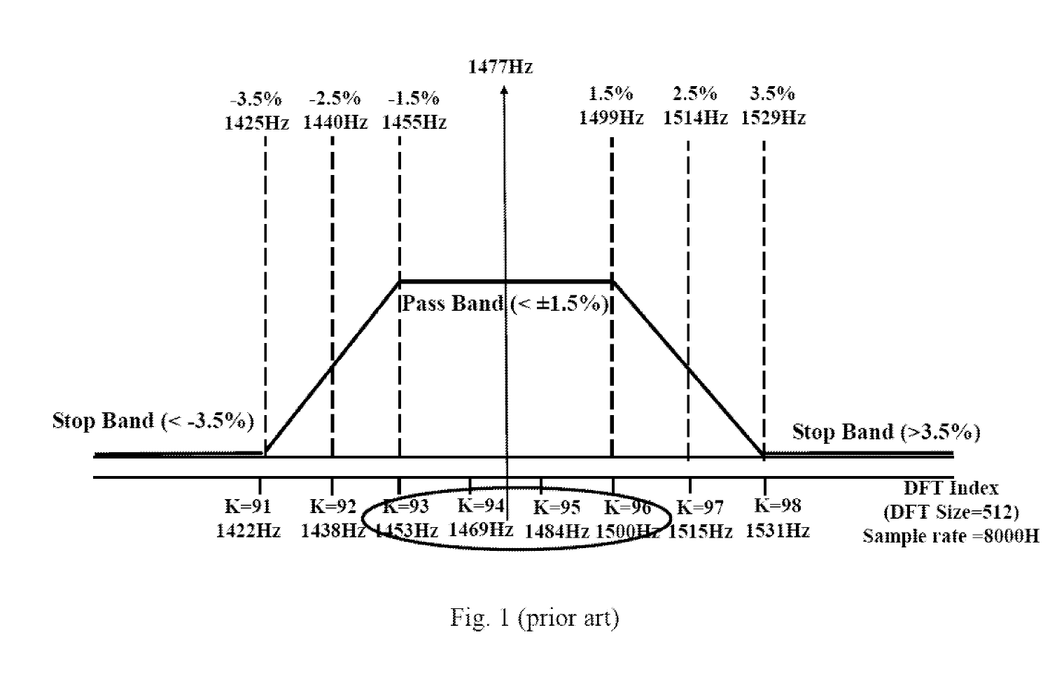

FIG. 2 shows schematically that k is proportional to frequency.

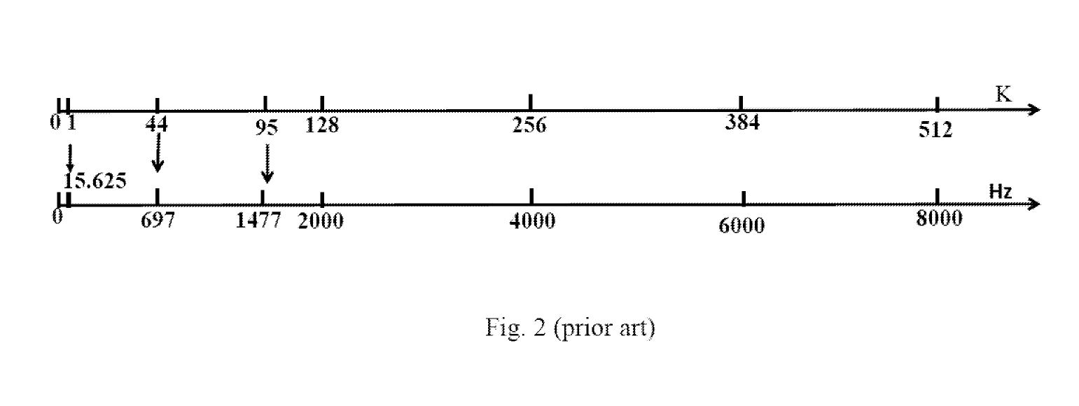

FIG. 3 shows schematically that a θ degree is added to control the wave shape.

### DETAILED DESCRIPTIONS OF THE PREFERRED EMBODIMENTS

Since the calculation for DFT is too much in prior art, the present invention therefore provides a new algorithm DMFT (Discrete Multi-Frequency Transform).

In prior art of DFT, in order to judge a DTMF signal “3”, five points of K=96˜92 (frequency tolerance range ±2.5% of 1477 Hz) and three points of K=45˜43 (frequency tolerance range ±2.5% of 697 Hz) have to be calculated, i.e. the value of X[k] must be calculated 8 times consecutively. But in the present invention the value of X[k] is only calculated once for each frequency. To detect a DTMF signal “3”, a high frequency and a low frequency are required for calculation of X[k], the mathematical formula is as below:

$$\begin{matrix}\tilde{X} [ k ] = {\sum }_{k = 0}^{M - 1} X [ k ] \\ = {\sum }_{k = 0}^{M - 1} x [ n ] {\sum }_{n = 0}^{N - 1} {W}_{N}^{kn} \\ = {\sum }_{k = 0}^{M - 1} x [ n ] {\sum }_{n = 0}^{N - 1} {e}^{j \frac{2 π}{N} kn} \\ = {\sum }_{k = 0}^{M - 1} x [ n ] {\sum }_{n = 0}^{N - 1} \{ cos ( \frac{2 π}{N} nk ) - j sin ( \frac{2 π}{N} nk ) \} \\ = {\sum }_{n = 0}^{N - 1} x [ n ] {\sum }_{k = 0}^{M - 1} \{ cos ( \frac{2 π}{N} nk ) - j sin ( \frac{2 π}{N} nk ) \}\end{matrix}$$

M is the length of k. If k=96˜92, then M is 5; if k=45˜43, then M=3. The cosine value and the sine value can be added individually, and then multiplied with x[n] so as to save a lot of calculation.

However, when the cosine value and the sine value are added individually, elimination or superposition of the phase will occur to make a smooth wave become a continuous trembling wave. Therefore the present invention adds a θ degree to control the wave shape, so that there is no trembling wave in the Pass-band of the frequency domain, or to reduce the trembling degree thereof, and make it work as a square wave filter like Butterworth or Chebyshev. Renew the formula as below:

$$\begin{matrix}\breve{X} [ k ] = {\sum }_{n = 0}^{N - 1} x [ n ] {\sum }_{m = 0}^{M - 1} {\breve{W}}_{Nθ}^{kn} \\ = {\sum }_{n = 0}^{N - 1} x [ n ] {\sum }_{m = 0}^{M - 1} {e}^{- j \frac{2 π n ( k + m )}{N} + ( m θ )} \\ = {\sum }_{n = 0}^{N - 1} x [ n ] {\sum }_{m = 0}^{M - 1} \{ cos ( \frac{2 π n ( k + m )}{N} + ( m θ ) ) - j sin ( \frac{2 π n ( k + m )}{N} + ( m θ ) ) \}\end{matrix}$$

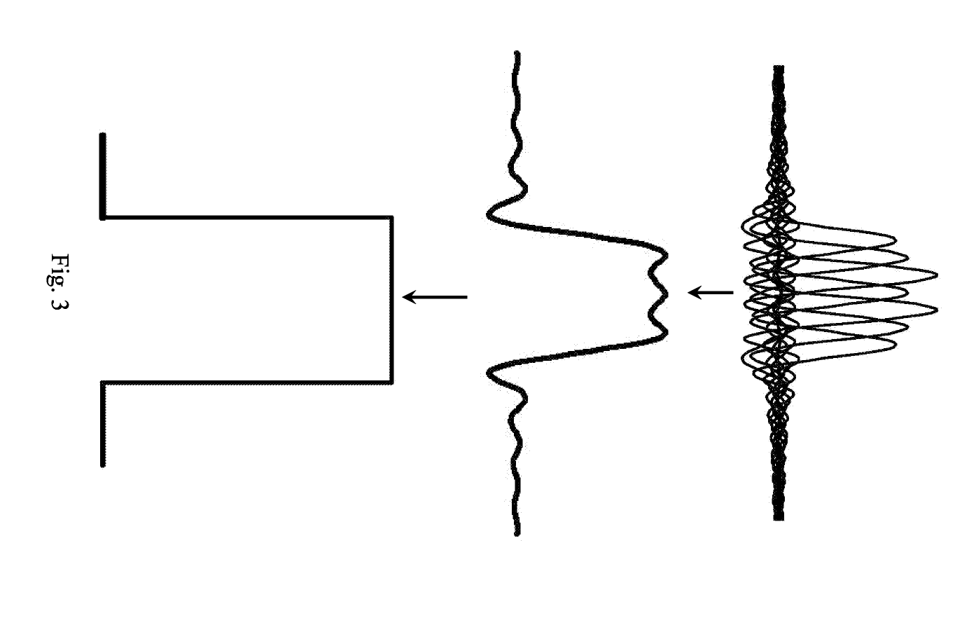

FIG. 3 shows schematically that a θ degree is added to control wave shape. Each individual wave is the DFT wave for each X[k]. As shown in the top graph in FIG. 3, even the individual waves are added directly, the correct DTMF signal cannot be judged. The present invention provides the new algorithm, and is shown in the middle graph and the bottom graph in FIG. 3, in which a best θ degree is added to make the individual waves to be added so as to form an optimized square wave filter.

The scope of the present invention depends upon the following claims, and is not limited by the above embodiments.

What is claimed is:

1. An algorithm for DTMF (Dual-Tone Multi-Frequency) detection, in detecting DTMF signals, the signals x[n] in time domain is converted into a spectrum in frequency domain, the sampling length is N, and perform calculation on M points of the spectrum within K frequency range,
$$\begin{matrix}\tilde{X} [ k ] = {\sum }_{k = 0}^{M - 1} X [ k ] \\ = {\sum }_{k = 0}^{M - 1} x [ n ] {\sum }_{n = 0}^{N - 1} {W}_{N}^{kn} \\ = {\sum }_{k = 0}^{M - 1} x [ n ] {\sum }_{n = 0}^{N - 1} {e}^{j \frac{2 π n}{N} kn} \\ = {\sum }_{k = 0}^{M - 1} x [ n ] {\sum }_{n = 0}^{N - 1} \{ cos ( \frac{2 π}{N} nk ) - j sin ( \frac{2 π}{N} nk ) \} \\ = {\sum }_{n = 0}^{N - 1} x [ n ] {\sum }_{k = 0}^{M - 1} \{ cos ( \frac{2 π}{N} nk ) - j sin ( \frac{2 π}{N} nk ) \}\end{matrix}$$
in which x[k] is the signal value at the k point of the spectrum, X[k] is the calculation result on M points of the spectrum.

2. The algorithm for DTMF (Dual-Tone Multi-Frequency) detection according to claim 1,
$$\begin{matrix}\breve{X} [ k ] = {\sum }_{n = 0}^{N - 1} x [ n ] {\sum }_{m = 0}^{M - 1} {\breve{W}}_{Nθ}^{kn} \\ = {\sum }_{n = 0}^{N - 1} x [ n ] {\sum }_{m = 0}^{M - 1} {e}^{- j \frac{2 π n ( k + m )}{N} + ( m θ )} \\ = {\sum }_{n = 0}^{N - 1} x [ n ] {\sum }_{m = 0}^{M - 1} \{ cos ( \frac{2 π n ( k + m )}{N} + ( m θ ) ) - j sin ( \frac{2 π n ( k + m )}{N} + ( m θ ) ) \}\end{matrix}$$
wherein the phase θ is a degree added to control the wave shape, so that there is no trembling wave, and make it work as a square wave filter to filter out quickly the required frequency and signal.
